(19) United States
(12) Patent Application Publication
(10) Pub. No.: US 2012/0222055 A1
(43) Pub. Date: Aug. 30, 2012

(54) Billing with QR Codes

(75) Inventors: Germar Schaefer, Monument, CO (US); John T. Kennedy, Denver, CO (US)

(73) Assignee: EchoStar Technologies L.L.C., Englewood, CO (US)

(21) Appl. No.: 13/035,525

(22) Filed: Feb. 25, 2011

(51) Int. Cl. H04N 7/16; G06Q 30/00

(52) U.S. Cl. 725/5; 705/40; 235/379

(57) ABSTRACT

Disclosure is directed to receiving billing information at a television receiver and communicating that billing information to a user's mobile device. The television receiver may create a two-dimensional barcode with billing information and output the two-dimensional barcode for display on a display device. Once displayed on the display device, the two-dimensional barcode may be scanned into a mobile device where the billing information may be used to allow a user to view billing information and/or submit payment information through the mobile device.

### TECHNICAL FIELD

Embodiments discussed herein are generally directed to communicating billing information to a mobile device through a displayed two-dimensional barcode such that a user may view the billing information and/or submit payments through the mobile device.

### BACKGROUND

Subscribers who receive cable television, satellite television, or other types program services are typically billed by their service provider on an on-going basis. Some subscribers set-up automated funds transfer from a credit card or bank in order to pay the bills that they receive. Other subscribers prefer to review their bill each billing period and submit their payment manually, Here, the subscriber may employ such payment mechanisms as sending a check in the mail, submitting a credit card number through an online system, submitting payment information to a billing department over the phone, and so on. For those subscribers that choose not to use automatic funds transfer and instead pay their bills manually, there is a need to provide a convenient payment mechanism.

### SUMMARY

Embodiments discussed herein are generally directed to receiving billing information at a television receiver and communicating that billing information to a user or subscriber. The television receiver may create a two-dimensional barcode with billing information and output the two-dimensional barcode for display on a display device. Once displayed on the display device, the two-dimensional barcode may be scanned into a mobile device where the billing information may be used to allow a user to view the billing information and/or submit payment information through the mobile device. In some embodiments, the manner in which the two-dimensional bar code is displayed may depend on when a payment is due. For payment dates that are not imminent, the two-dimensional bar may be displayed only in response to specific user requests. For payment dates that are imminent, the two-dimensional bar code may be displayed to the user without a specific request. For overdue payments, service may be suspended and the two-dimensional bar code may be displayed until payment is received.

One embodiment is directed to a billing method, comprising: receiving billing information at a television receiver from a service provider; creating at least one two-dimensional barcode using the billing information received from the service provider; and outputting the two-dimensional barcode from the television receiver for display on a display device; wherein, when the two-dimensional barcode is scanned from the display device into a mobile device, the two-dimensional barcode conveys the billing information to the mobile device such that a user may submit a payment to the service provider through the mobile device.

Another embodiment is directed to a method, comprising: scanning a two-dimensional barcode into a mobile device, the two dimensional bar code being displayed on a display device associated with a television receiver; displaying billing information at the mobile device, the billing information being encoded in the two-dimensional barcode scanned into the mobile device; receiving payment information from a user at the mobile device; and transmitting the payment information from the mobile device to the service provider.

Another embodiment is directed to a television receiver, comprising: a tuner operable to receive a program service transmission having a plurality of channels, the tuner operable to select one of the channels and to prepare the channel to be output in a data signal to a display device; a memory connected to the tuner, the memory including a tangible storage medium operable to store computer readable data and instructions; a processor connected to memory operable to run computer executable code stored in the memory; a billing module configured to execute on the processor to receive billing information from a service provider; an encoding module configured to execute on the processor to create a two-dimensional barcode that includes the billing information received from the service provider; an output module configured to execute on the processor to output the two-dimensional barcode from the television receiver for display on a display device; wherein, when the two-dimensional barcode is scanned from the display device into a mobile device, the two-dimensional barcode conveys the billing information to the mobile device such that a user may submit a payment to the service provider through the mobile device.

### BRIEF DESCRIPTION OF THE DRAWINGS

FIG. 1 is a schematic diagram showing a sample system, components and implementations discussed herein;

FIG. 2 is a flow chart that illustrates a method executed by the television receiver illustrated in FIG. 1;

FIG. 3A-3B are illustrations of outputs shown on a display device in connection with the operation of the method illustrated in FIG. 2;

FIG. 4 is a flow chart that illustrates a method executed by the mobile device illustrated in FIG. 1;

FIG. 5A-5D are illustrations of output shown on a mobile device in connection with the operation of the method illustrated in FIG. 4;

FIG. 6 is a flow chart that illustrates another method executed by the television receiver illustrated in FIG. 1;

FIG. 7 is a flow chart that illustrates another method executed by the television receiver illustrated in FIG. 1;

FIG. 8 is an illustration of output shown on a display device in connection with the operation of the method illustrated in FIG. 6; and

FIG. 9 is an illustration of output shown on a display device in connection with the operation of the method illustrated in FIG. 7.

### DETAILED DESCRIPTION

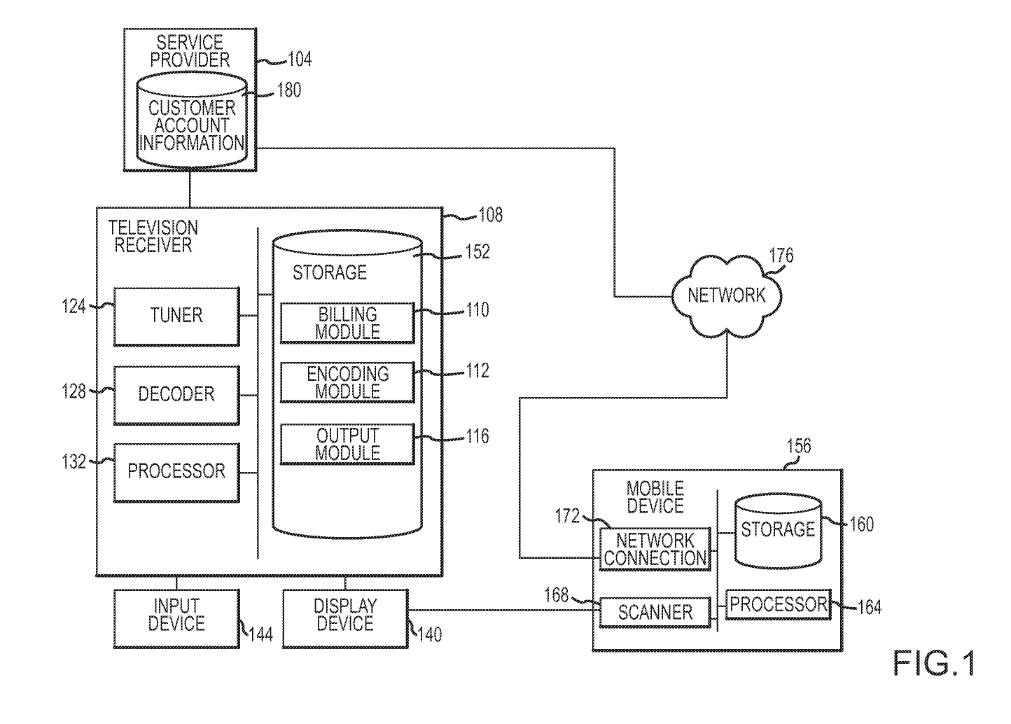

FIG. 1 is a schematic illustration of a general operating environment showing components and features of embodiments discussed herein. FIG. 1 includes a television receiver, generally identified by reference numeral 108. Embodiments discussed herein are generally directed to receiving billing information at the television receiver 108 and communicating that billing information to a user or subscriber through the use of one or more two-dimensional barcode(s). The user may scan a two-dimensional bar code into his or her mobile device 156 in order to view the billing information and/or submit payment information through the mobile device 156.

The receiver 108 depicted in FIG. 1 may be configured to communicate with or receive signals from a service provider 104 that broadcasts, transmits, or otherwise delivers a content service to a receiver 108. The receiver 108 can include a set-top box (STB), a digital video recorder (DVR), a cable receiver, a general purpose computing device, and so on. The receiver 108 may also include a cable modem that receives streaming video and/or audio. Generally, a “receiver” may be any device capable of receiving video and/or audio content included in a broadcast or other content service transmission from a service provider 104.

The receiver 108 may be associated with an individual, business or other entity, user or subscriber that receives a content service transmission from the service provider 104. Generally the terms “user” and/or “subscriber” refer to an individual or company who receives a content service transmission. This may include those who have purchased a subscription to the content service transmission. Alternatively or additionally, the terms “user” and/or “subscriber” may refer to individuals who have been given access to the content service transmission through promotional offers and/or other non-fee-based agreements.

As used herein, a “service provider” may include any service that provides a content transmission to a receiver 108 such as, without limitation, a satellite television service, a direct television service or a cable television service, or a streaming video delivered across a network such as the Internet. Accordingly, a “content service transmission” encompasses transmission of information across a cable network (for example from a cable headend to a cable receiver), an Internet or other computer-accessible medium (including a local area network, wide-area network, and so on), including Internet protocol television transmissions, a wireless network such as a radio frequency or infrared network, and so on.

In connection with embodiments that operate in the context of a satellite television service, the service provider 104 may provide a content service transmission through an uplink center. Such a satellite television service may utilize a direct broadcast satellite (DBS) system, which can incorporate packetized transmission signals according to an appropriate standard, such as the MPEG-2 and/or MPEG-4 standards. The uplink center may include a transmitter or other equipment operable to transmit a modulated signal having data representing audio and/or visual content. The modulated signal may be received at a satellite, which in turn retransmits the modulated signal to be received at one or more terrestrial locations. The retransmitted signal may be received from the satellite at one or more satellite dishes, which are typically associated with one or more receivers 108. In connection with embodiments that operate in the context of a cable television service, the service provider 104 may provide a content service transmission to a headend, which, in turn, delivers the content service transmission to the receiver 108.

The receiver 108 may include a tuner 124 operable to receive the content service transmission signal from the service provider 104 and a decoder 128 to decode the received signal. The decoder 128 may be programmed to decrypt, demodulate, demultiplex or otherwise decode some or all of the received signals in accordance with purchases and selections made by a user. Output from the decoder 128 may be directed to an audio visual (A/V) processing module or other signal output portion, which may process the video and audio streams using digital-to-analog conversion techniques, or compressed digital to uncompressed digital conversion techniques, to produce one or more output signals. The output signals may be sent to a display device 140, such as a television or monitor in order to display content to a user.

The receiver 108 may include or be associated with a memory or other storage device 152, such as magnetic or optical storage. The storage device 152 may be operable to store data received from the decoded content transmission signal. The storage device 152 may be volatile or non-volatile memory implemented using any suitable technique or technology such as, for example, random access memory (RAM), disk storage, flash memory, solid state and so on. The storage device 152 may be located within the receiver 108 or separately from the receiver 108. The storage device 152 may removable. The stored data set may include audio and/or visual content to be transmitted and output through a display device, such as a television or monitor. Generally, audio/visual content may include still images, video images, animation and/or audio. Portable Network Graphics (PNG) or other appropriate formats, such as for example, Tagged Image File Format (TIFF), Joint Photographic Experts Group (JPEG), Motion Picture Experts Group (MPEG)-2, MPEG-4 may be used to display an image or video.

The receiver 108 may additionally include a processor 132 operable to run executable code in connection with various functions associated with the receiver 108. For example, the processor 132 may display graphics, images, animations or other content through an output device, such as a television or monitor. The storage device 152 may store an application, file, or other data that is useable by the processor 132. As used herein, an application includes processor executable code that may be run to carry out one or more functions associated with the receiver 108. “Processor executable code” includes any computer-readable media or commands that may be ultimately interpreted by a processor, such as HTML or XML files that are rendered into user-viewable applications by an application executed by the processor 132.

The processor 132 may also perform such tasks as executing commands received from a user. User commands may be sent to the receiver 108 through a user input device 144 such as remote or other wireless device. As used herein, a “user input device” may include any device operable to receive input from a user and to convey the input to the receiver 108. In one embodiment, the user input device 144 may be a hand-held device having a number of buttons or keys that when actuated by a user cause the user input device to covey information to the receiver 108 using a suitable communication means, such as an infrared signal. The user input device 144 may include a pointing device or functionality that allows the user to control the position of a cursor that is displayed on an output device. For example, the user input device 144 may include a track ball or glide plane that may be manipulated to control cursor movements. The user input device 144 may include a motion sensor or accelerometer that allows a user to control displayed items or graphics, such as a cursor, through movements of his or her hand or arm that cause a displacement of the user input device 144. It should be appreciated that other input devices such as a computer mouse or touch screen may be used and other communication means, wired or wireless, may be used. Information sent to the receiver 108 may include, for example, a command to change the output channel. Commands sent to the receiver 108 may be entered through a dedicated display menu.

The storage device 152 may store units of processor executable code in the form of one or more modules configured to implement certain functions described herein. Embodiments discussed herein are directed to receiving billing information at a television receiver 104 and communicating that information to a mobile device 156. In receiving and communicating billing information, the storage device 152 may include a billing module 110 that is configured to at least receive and/or process billing information received from the service provider 104.

In communicating with the mobile device 156, the television receiver 108 typically creates a two-dimensional barcode with billing information and outputs the two-dimensional barcode for display on a display device 140. As used herein, a “two-dimensional barcode” is a machine readable representation of data that includes a pattern of bars, squares, dots, hexagons or other geometric forms. The geometric forms are arranged within the two-dimensional barcode to form a message according to a predefined symbology that defines the meaning of various symbols. In some implementations, the two-dimensional barcode may arrange symbols in a grid or matrix. In other implementations, the symbols of the two-dimensional barcode may be arranged in a circular patterns. In still other implementations, steganography techniques may be used to encode symbols within an image in such a way that a viewer is not aware of the symbols. One example of a two-dimensional barcode is QR code, developed by the Denso-Wave corporation of Japan. Another example of a two-dimensional barcode is Aztec code, developed by Andrew Longacre, Jr. and Robert Hussey.

The receiver 104 may include an encoding module 112 configured to create a two-dimensional barcode with one or more codes corresponding to billing information received by the billing module 110. Once the encoding module 112 creates two-dimensional barcode having the appropriate information, an output module 116 may output the two-dimensional barcode from the television receiver 104 for display on the display device 140. Once displayed on the display device 140, the two-dimensional barcode may be scanned into the mobile device 156 where the billing information may be provided to the user.

Generally, the mobile device 156 may include a processor 164 operable to load and store various processor-executable modules stored in the storage device 160. The mobile device 148 may additionally include an input device, such a keypad or keyboard, and an output device, such as an LED or LCD screen. In addition to processor-executable code, the storage device 160 may store data associated with two-dimensional barcodes that are scanned into the mobile device 156 from the receiver 108. In this regard, the mobile device 156 may include a scanner 168 that is operable to scan or otherwise read a two-dimensional barcode. In one embodiment, the scanner 168 may be a photo-sensor or laser scanner that operates by sweeping a beam of light across a surface that displays the two-dimensional barcode. In other embodiments, the scanner 168 may be charge-coupled device, such a digital camera, that is operable to capture an image of the two-dimensional barcode. In connection with capturing an image of the two-dimensional barcode, the mobile device 156 may be configured to extract information contained in the two-dimensional barcode using digital signal processing or other appropriate techniques.

The mobile device 156 may be operable to transfer content across a network 176 to the service provider 104 or to a customer account database 180 associated with the service provider. Network transactions may be conducted through the operation of a network interface 172, such as a modem network interface component, cable plug or jack, and so on. Using the interface, the mobile device 156 may communicate over a network 176, such as a packet switched network or a circuit switched network, one example of which is the public switched telephone network (PSTN). It should be appreciated that the network 176 may be any type of network capable of data communication, such as, for example, a local or wide area network or the Internet. The mobile device 156 may communicate through a network connection using any suitable communication protocol such as TCP/IP.

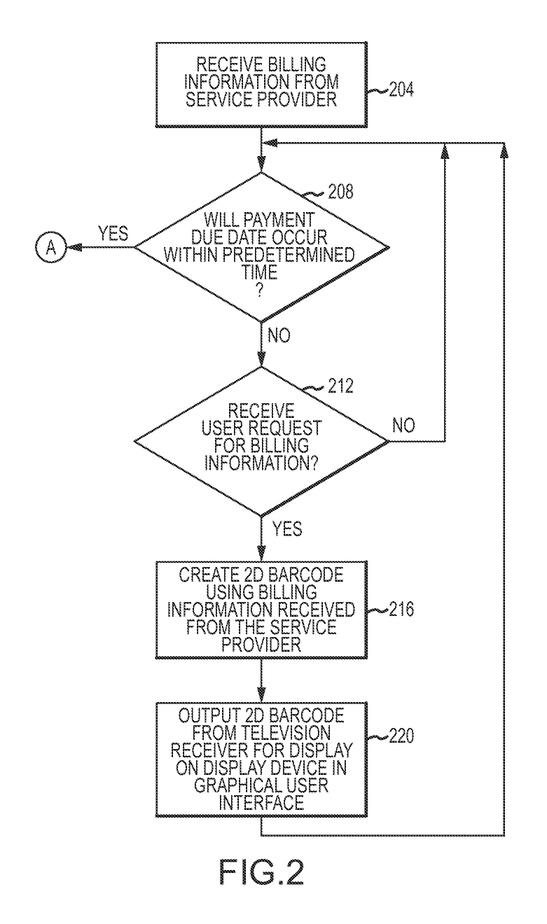

FIG. 2 is a flowchart that illustrates a method of communicating billing information from a television receiver 108 to a mobile device 156. Initially, in operation 204, the billing module 110 receives billing information from the service provider 104. The billing module 110 may receive the billing information through a down-linked satellite signal, network transaction or other appropriate mechanism. The billing information received in operation 204 may include, for example, account information such as the name and address of the subscriber, an amount due, a due date, and so on. The billing information received in operation 204 may, in one embodiment, be a complete record of the subscriber's bill and/or billing history. In other embodiments, the billing information received in operation 204 may be an abbreviated version of the bill which provides the subscriber with certain details regarding his account or his amount payable and an embedded link that may used to retrieve further information through a network transaction. Following operation 204, operation 208 may be executed.

In operation 208, the billing module 110 may determine if a payment due date will occur within a predetermined timeframe. Specifically, the billing module 110 determines that the due date for payment is approaching and the user or subscriber should be informed of this fact. The predetermined time period may vary depending upon certain factors that indicate the optimal time in which to inform a subscriber of a payment date. For example, the predetermined time may be two weeks before the due date, one week before, three days before, and so on. In one embodiment, the due date may be determined from information received by the billing module in operation 204. In other embodiments, the billing module 110 initiates a network transaction or call up procedure to retrieve the information from the service provider 104.

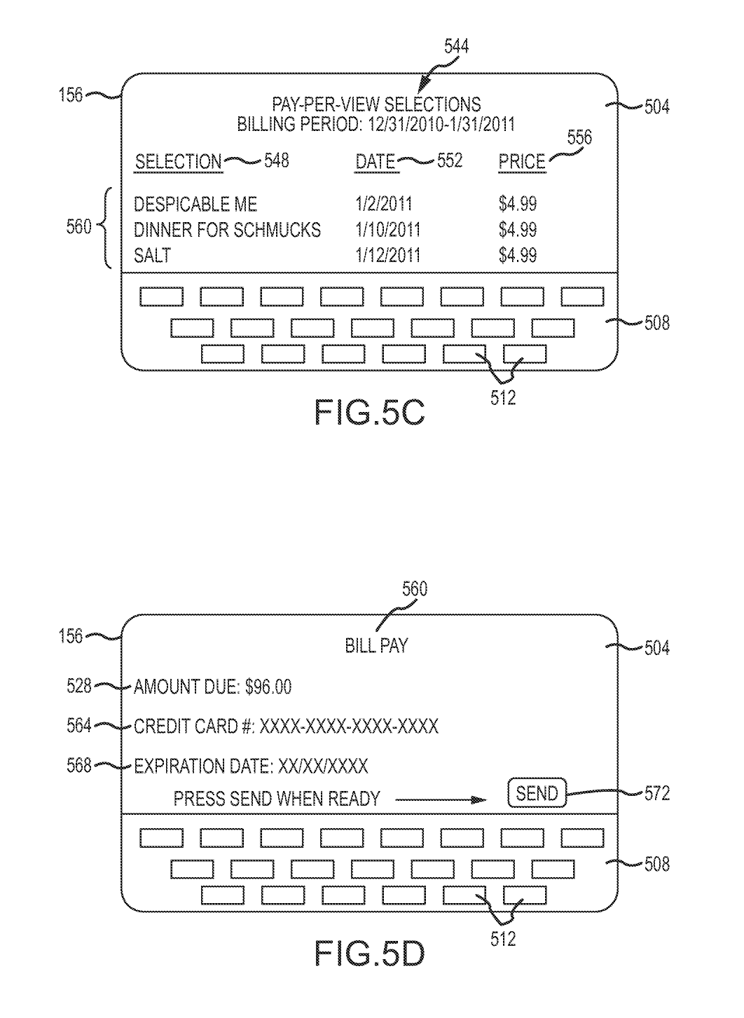

If, in operation 208, the billing module 110 determines that payment will be due within the predetermined time period, billing information may be output to the user without any specific user request for the billing information. The receiver operations directed to outputting billing information in this manner are set forth in FIG. 6 and described in greater detail below. If, in operation 208, the billing module determines that the payment due date will not occur within the predetermined time, operation 212 may be executed.

In operation 212, the billing module 110 may determine if a user request for billing information has been received at the television receiver 108. Any request for billing information may be input to the television receiver 108 through various commands entered through the user input device 144 and/or through a graphical user interface displayed on the display device 140. In operation 212, if the billing module 110 determines that a request for billing information has not been received, operation 208 may follow operation 212. In this instance, the billing module 110 may operate in a loop or other time-delayed function such that the billing module 110 waits for either the payment date to be within the predetermined time or for the user to specifically request the billing information. Within this loop, the billing module will not output billing information to the user without a specific request to do so.

If, in operation 212, the billing module 110 receives a user request for billing information, operation 216 may be executed. In operation 216, the encoding module 112 may create a two-dimensional barcode using the billing information received from the service provider 104. Following operation 216, operation 220 may be executed. In operation 220, the output module 116 may output the two-dimensional barcode from the television receiver 108 for display on the display device 140. In one embodiment, the two-dimensional barcode is output from the display device 140 in connection with a graphical user interface.

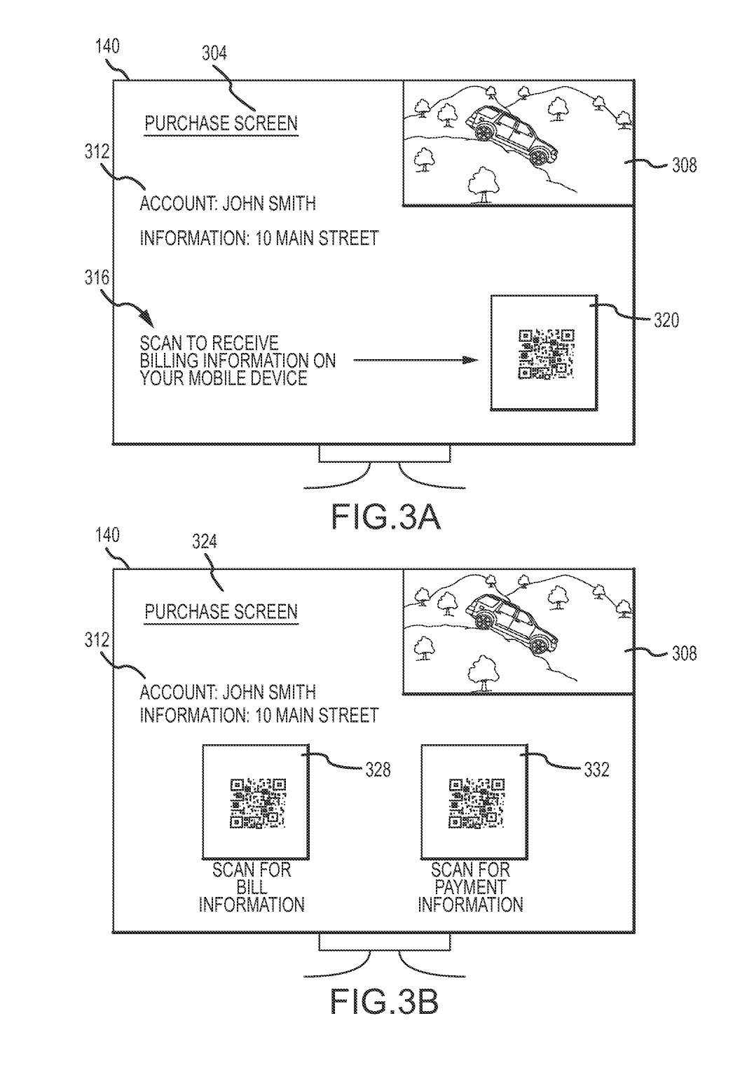

FIGS. 3A and 3B are illustrations of output displayed on the display device 140. FIG. 3A is an illustration of an example purchase screen 304 that may be shown in connection with operation 216, shown in FIG. 2. The purchase screen 304 may include a window 308 that shows a reduced or scaled down version of normal programming content. Through the window 308, normal programming may be viewed simultaneously with information conveyed through the purchase screen 304 or other screen discussed herein. Purchase screen 304 may be accessed through a user request for billing information entered through the user input device 144. The purchase screen 304 may include a certain amount of account information 312. By way of example, the account information 312 shown in FIG. 3A includes the name and address of the subscriber to the television service. Additionally, the purchase screen 304 may include a two-dimensional barcode 320. The two-dimensional barcode 320 may additionally be accompanied by instructions 316 that direct the user to scan the two-dimensional barcode 320 into his or her mobile device 156.

The displayed two-dimensional barcode 320 may include billing information encoded into the barcode 320. The two-dimensional barcode 320 may include information such as payment due date and a payment amount. In addition, the two-dimensional barcode 320 may include routing information or other access information usable by the mobile device 156 to acquire more detail for the accounts and/or for the current bill due to be paid by the subscriber. In certain embodiments, a purchase screen may display more than one two-dimensional barcode to convey a greater deal of information directly to the mobile device 156.

FIG. 3B includes a purchase screen 324 having two barcodes. The purchase screen 324 includes a window 308 operable to view programming content. The purchase screen 324 may include a certain amount of account information 312. Additionally, as shown in FIG. 3B, the purchase screen 324 includes a first two-dimensional barcode 328. In one example, the first two-dimensional barcode 328 may be encoded with billing information. For example, the information encoded in the first two-dimensional barcode 328 may allow the mobile device 156 to view the subscriber's current bill, the subscriber's past bill and/or certain purchases made during the current billing period. Additionally, purchase screen 324 includes a second two-dimensional barcode 332. In one example, the second two-dimensional barcode 332 may be encoded with payment information or routing information operable to allow the mobile device 156 to receive and route payment information. For example, the second two-dimensional barcode 332 may include a link or other access information to a payment system associated with the service provider 104. In addition, the two-dimensional barcode 332 may include prompts for credit cards, bank routing data, and so on. Once displayed on the display device 140, the barcode or barcodes may be scanned into the mobile device 156.

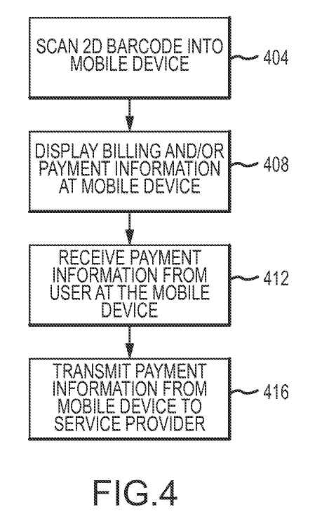

FIG. 4 is a flowchart that illustrates a method for scanning billing information into a mobile device 156. In one example, the mobile device may scan two-dimensional barcodes displayed on the display device 140, such as discussed in connection with FIGS. 2, 3A and 3B. Initially, in operation 404, the mobile device 156 may scan the two-dimensional barcode into the mobile device 156. In operation 404, a specifically designed two-dimensional barcode scanner or a camera may scan or photograph the two-dimensional barcode as it is displayed on the display device 104. Following operation 404, operation 408 may be executed.

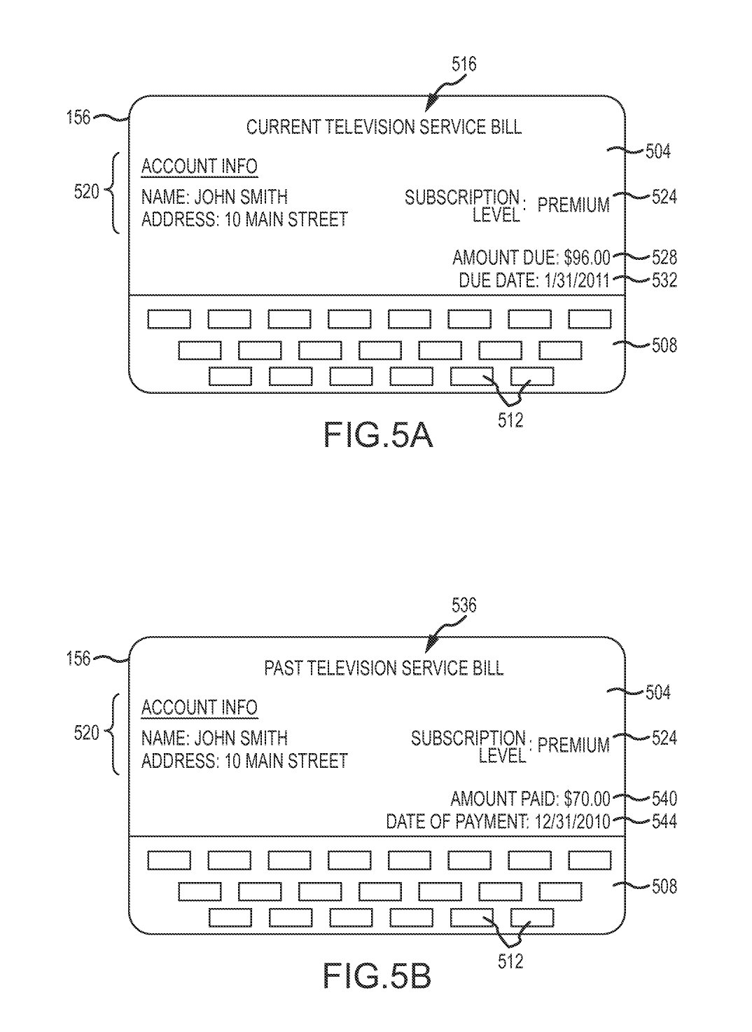

In operation 408, the mobile device 156 may display billing and/or payment information on its screen or other output device that is extracted from a scanned two-dimensional bar. As described in connection with FIGS. 5A-5D, the operation 408 may include one or more screens or menu that display information regarding the user's account and/or bills, past or present. Following operation 408, operation 412 may be executed.

In operation 412, the mobile device 156 receives payment information from the user. In operation 412, the user may enter payment information such as credit card numbers, bank routing numbers and so on through inputs entered through a keyboard associated with the mobile device 156. The payment information can be entered in response to certain prompts displayed on a display device associated with the mobile device 156. Following operation 412, operation 416 may be executed. In operation 416, the mobile device 156 may transmit payment information from the mobile device 156 to the service provider 104. Operation 416 may include a network transaction initiated and conducted across the network 176.

FIGS. 5A-5D illustrate outputs displayed at the mobile device 156 in connection with displaying payment information and/or payment prompts as described in connection with FIG. 4. The billing information that is conveyed to the user as shown in FIG. 5A-5D may be extracted from a two-dimensional bar code that is displayed on the display device 140 and scanned into the mobile device 156 through the operation of the scanner 168. Depending on the quantity of information conveyed to the user, the mobile device 156 may retrieve information from the scanned barcode only, or from the scanned bar code and from the customer account information database 180. If a large quantity of billing information is to be conveyed to the user, the scanned two-dimensional barcode may include an encoded link or network address that may be used by the mobile device 156 to contact the customer account information database 180 through a network transaction across the network 176. In one embodiment, the scanned two-dimensional bar code may include a website address and access credentials that the mobile device 156 may use to automatically bring-up a service provider website having the customer's billing and/or payment information.

In FIG. 5A, a mobile device 156 is shown. The mobile device 156 includes an output screen 104 and an input mechanism, such as a keyboard 508. As shown in FIG. 5A, the keyboard 508 includes a number of keys 512. Depending upon the implementation, the keys 512 may be virtual keys displayed on a portion of the output device 504. In alternative embodiments, the keyboard may consist of physical keys arranged on a physical keyboard. As shown in FIG. 5A, the output device 504 displays a current television service bill 516. The current television service bill 516 may include detailed information regarding the subscriber's television service and information regarding payment required in connection with that service. The current television service bill 156 may include a virtual copy of a bill that would otherwise be sent to the subscriber through the mail. The current television service bill 516 may include account information 520. By way of example, the account information 520 shown in FIG. 5A includes a name and address for the account subscriber. Additionally, the current television service bill 516 may include a subscription level 524 that indicates the type of service plan currently provided to the user. The current television service bill 516 may additionally include payment information such as an amount due 528 and a due date 532.

In accordance with certain embodiments discussed herein, the user may input various commands through the keyboard 508 to view information regarding previous billing statements and/or previous purchases which may be reflected in the current amount due 528. FIG. 5B includes a past television service bill 536 that may be accessed through commands entered into the keyboard 508. The past television service bill 536 may include account information 520, a subscription level 524, and so on. Additionally, the past television service bill 536 may include a past amount paid 540 and a date of payment 544.

FIG. 5C is an illustration of a pay-per-view selection menu 544 that may be accessed through the mobile device 156. The pay-per-view selection menu 544 may display certain pay-per-view selections 560 that have been accessed by the subscriber during a certain billing period. A user may access the pay-per-view selection menu 544 in order to verify the current amount due 528 as shown on the current television service bill menu 516. The pay-per-view selections menu 544 may display the selections in a grid format including, for example, a column for the pay-per-view selections 548, a column for the date 552 in which the various selections were viewed or purchased, and a price column 556 showing the price paid or agreed to be paid by the user or subscriber in connection with the particular pay-per-view selection.

FIG. 5D is an illustration of a bill pay menu 560 that may be accessed by commands entered into the mobile device 156. The user may access the bill pay menu 560 when he or she has reviewed his current bill, past bill, his pay-per-view selections and so on. The bill pay menu 560 may include an amount due 528. This amount due 528 may correspond to the amount due shown on the previous current television service bill menu 516. Additionally, the bill pay menu 560 may include a credit card prompt 564, which instructs the user to input his credit card information along with the credit card number prompt 564. An expiration date prompt 568 may additionally be displayed. The bill pay menu 560 may also include an icon or button 572 that may be used by the subscriber to confirm the payment made through the bill pay screen 560.

FIG. 6 is a flow chart that illustrates a method of displaying billing information from the television receiver 108. As indicated above, FIG. 6 illustrates a method of handling time sensitive billing information. Specifically, initial operation 604 may be executed following a determination made in operation 208 of FIG. 2 that the payment will be due within a certain predetermined timeframe. In operation 604, the encoding module 112 creates a two-dimensional barcode using billing information received from the service provider 104. Following operation 604, operation 608 may be executed. In operation 608, the two-dimensional barcode may be output from the television receiver 108 for display on the display device 144.

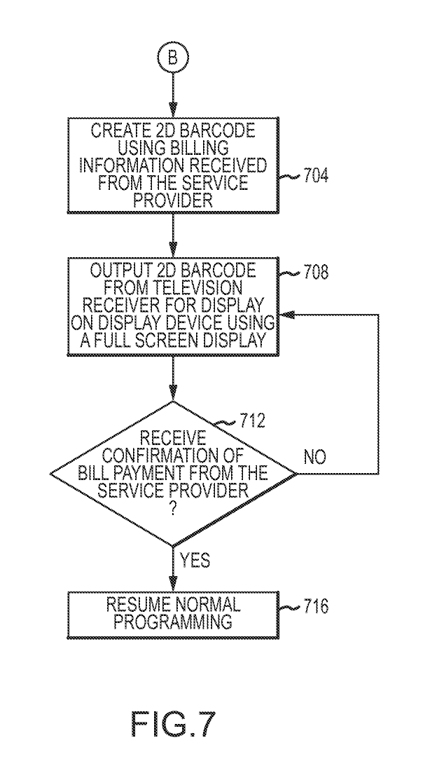

In operation 608, the two-dimensional barcode may be output from the display device 140 in a manner that does not require specific user requests. In one embodiment, the two-dimensional barcode may be displayed in the form of a “pop-up” that appears on the display device. The pop-up may be an icon or other graphic which is overlaid on top of the normal programming content shown on the display device 140. By way of example, FIG. 8 is an illustration of such a icon 808 displayed to the user. FIG. 8 includes output displayed on the display device 140 that includes typical programming content 804 and the icon 808 overlaid on top of the normal programming content 804. By way of example and not limitation, the icon 808 is shown in FIG. 8 in the bottom right hand corner of the display device 140. The icon 808 may include text 812 that informs the user of the time sensitive television service bill. For example, the displayed text 812 may indicate that the payment is due within one week and may provide instructions for the user to scan a displayed two-dimensional barcode 816 into his mobile device 156 in order to facilitate bill pay.

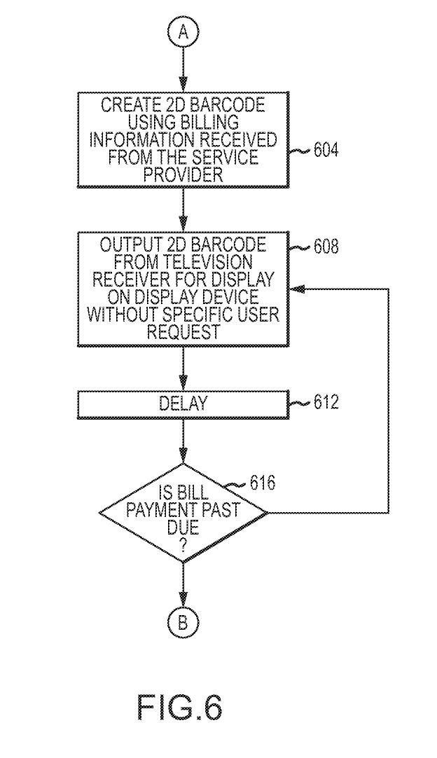

Operation 608 may include displaying the icon 808 to the user for a specific and limited period of time. Here, the television service payment is not yet overdue. Accordingly, the pop-up or icon 808 may be displayed to the user by way of reminder and in a manner that is not overly intrusive. Following operation 608, operation 612 may be executed. In operation 612, a delay function may be executed such that a certain period of time elapses before the next reminder is given to the user. By delaying the reminder, the system does not remind the user too frequently so as to be an annoyance to an otherwise loyal customer. Following operation 612, operation 616 may be executed. In operation 616, the billing module 110 may determine if the bill payment is past due. If, in operation 612, the billing module 110 determines that the bill payment is not past due, operation 608 may be executed such that another polite reminder is given to the user through an icon 808 displayed on the display device 140. If, in operation 616, the billing module 110 determines that the payment is past due, more forceful methods may be implemented as described in FIG. 7.

FIG. 7 is an illustration of a method of forcing a bill payment through the operation of the receiver 108. Initial operation 704 may follow operation 616 in FIG. 6 such that a determination is made that the bill payment is past due. In operation 704, the encoding module 112 may create a two-dimensional barcode using billing information received from the service provider 104. Following operation 704, operation 708 may be executed.

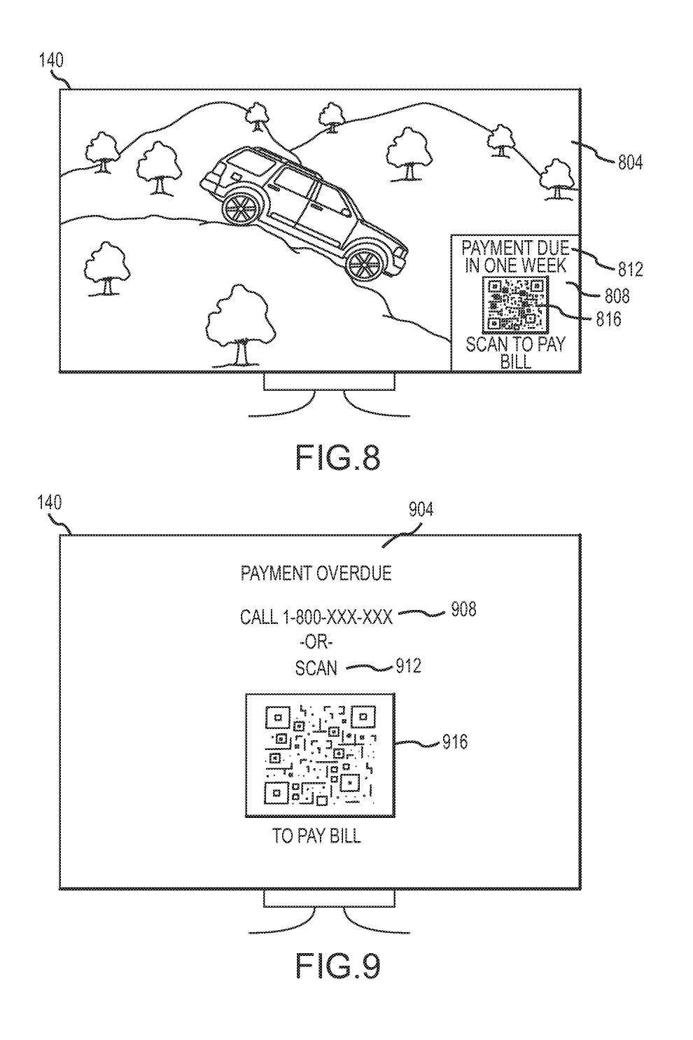

In operation 708, the two-dimensional barcode may be output from the television receiver 108 for display on the display device 140. In operation 704, the normal television program content may be suspended or interrupted and the displayed two-dimensional barcode may occupy the full screen of the display device 140 or a central portion thereof. Such a payment overdue screen is shown in FIG. 9. By way of example, the payment overdue screen 904 shown in FIG. 9 may includes a telephone number 904 that a subscriber may use to call customer service in the event that he does not have a two-dimensional barcode reader and/or mobile device having such a reader. In addition, the payment overdue menu 904 may include instructions 912 that instruct the user to scan a displayed two-dimensional barcode 916 into his or her mobile device 156. The instructions 912 may include text or other messages that tell the user that the displayed two-dimensional barcode 916 may be used in order to pay the outstanding service bill. In one embodiment, the payment overdue screen 904 is displayed to the user at a time in which the user watches one or more of his favorite channels.

The payment overdue screen 904 displayed in operation 708 may be held on the screen until such time as the user has paid his overdue bill. Specifically, operation 708 may be followed by operation 712 in which the billing module 110 determines if confirmation of bill payment has been received from the service provider 104. If, in operation 712, no confirmation is received, operation 708 may again be executed or may continue to be executed such that the payment overdue screen is displayed to the subscriber. If, in operation 712, the billing module 110 receives confirmation of bill payment from the service provider, operation 716 may be executed. In operation 716, the television receiver 108 may resume normal programming. Specifically, the payment overdue screen 904 may be removed and normal programming content may be again displayed through the display device 140.

By way of example and not limitation, some system elements described herein such as the billing module 110, the encoding module 112, and the output module 116 are depicted in the figures as processor executable software or code elements that are stored in a stored in a storage device 152. However, it should be appreciated that some system designs consistent with the teachings described herein may implement separate modules within a television receiver that serve the functions implemented by the illustrated billing module 110, the encoding module 112, and the output module 116. Such modules may include hardware and/or software elements that are implemented apart from the storage device 152. In some embodiments, such separate modules may utilize the storage device 152 for such purposes as loading and/or storing data.

While embodiments are discussed herein in connection with a exemplary satellite or cable broadcast system, it should be appreciated that embodiments may be used in connection other types of networks or content delivery mechanisms. Generally, the disclosure includes content delivered from a provider to a receiver across or over a network. The network across which content may be delivered may include satellite or cable system. Alternatively, the network may include a local area network, wide area network or the Internet. In connection with certain embodiments, a receiver may include a general purpose computer operable to receive data or other content across a network, such as a wide area network of the internet. In such embodiments, the computer may be configured so that a provider can access a web site, a file transfer protocol (FTP) site, a file sharing system or site, and so on. Moreover, the order of method operations, such those shown in FIG. 2, FIG. 4, FIG. 6, and FIG. 7, described herein is by way of example and limitation. Certain implementations may reorder method operations without departing from the spirit and scope of the disclosure.

1. A billing method, comprising:
receiving billing information at a television receiver from a service provider;
creating at least one two-dimensional barcode using the billing information received from the service provider; and
outputting the two-dimensional barcode from the television receiver for display on a display device;
wherein, when the two-dimensional barcode is scanned from the display device into a mobile device, the two-dimensional barcode conveys the billing information to the mobile device such that a user may submit a payment to the service provider through the mobile device.

2. The billing method of claim 1, further comprising:
determining that a payment due date will not occur within a pre-determined period of time, wherein the payment due date is included in the billing information;
wherein the operation of outputting the two-dimensional barcode is not executed until a specific request for account information is received at the television device from the user.

3. The billing method of claim 1, wherein:
the operation of creating at least one two-dimensional barcode includes creating a first two-dimensional barcode and a second two-dimensional barcode;
the first two-dimensional barcode configured to allow a user to view a television service bill on the mobile device; and
the second two-dimensional barcode configured to allow a user to submit a payment for the television service bill through the mobile device.

4. The billing method of claim 1, further comprising:
determining that a payment due date will occur within a pre-determined period of time, wherein the payment due date is included in the billing information;
wherein the operation of outputting the two-dimensional barcode includes outputting text to be displayed in connection with the two-dimensional barcode, the text including an alert indicating that a payment due date will occur within predetermined time.

5. The billing method of claim 4, wherein the two-dimensional barcode and the text are displayed on the display device in an icon that that overlays program content also displayed on the display device.

6. The billing method of claim 1, further comprising:
determining that a payment due date is past due; and
in response, suspending display of programming content at the television receiver;
wherein the two-dimensional barcode is displayed in a central location on the display device.

7. The billing method of claim 6, wherein the display of programming content is suspended during a display of a program that is on a user favorites list.

8. The billing method of claim 6, further comprising:
determining that a payment has been received at the service provider; and
in response, resuming normal programming at the television receiver.

9. The billing method of claim 6, wherein the two-dimensional barcode in displayed in combination with a telephone number for a billing department of the service provider.

10. The billing method of claim 1, further comprising:
encoding the two-dimensional barcode with routing information, wherein the mobile device uses the routing information to direct payment information input by the user to the service provider.

11. The billing method of claim 10, wherein:
the routing information includes a uniform resource locator configured to access a website through a browser operating on the mobile device; and
the website is configured to communicate the payment information to the service provider.

12. A method, comprising:
scanning a two-dimensional barcode into a mobile device, the two dimensional bar code being displayed on a display device associated with a television receiver;
displaying billing information at the mobile device, the billing information being encoded in the two-dimensional barcode scanned into the mobile device;
receiving payment information from a user at the mobile device; and
transmitting the payment information from the mobile device to the service provider.

13. The method of claim 12, wherein the operation of displaying billing information at the mobile device includes displaying at least one current television service bill and one past television service bill.

14. The method of claim 13, wherein the operation of displaying billing information at the mobile device includes displaying a list of pay-per-view items that were purchased during a billing period of the current television service bill.

15. The method of claim 12, wherein the two-dimensional barcode is encoded with a link to additional billing information, the method further comprising:
connecting to a data source using the link to additional billing information;
downloading and displaying the additional billing information at the mobile device.

16. The method of claim 12, wherein the operation of scanning the two-dimensional barcode includes taking a photograph of the two dimensional barcode using a camera component of the mobile device.

17. A television receiver, comprising:
a tuner operable to receive a program service transmission having a plurality of channels, the tuner operable to select one of the channels and to prepare the channel to be output in a data signal to a display device;
a memory connected to the tuner, the memory including a tangible storage medium operable to store computer readable data and instructions;
a processor connected to memory operable to run computer executable code stored in the memory;
a billing module configured to execute on the processor to receive billing information from a service provider;
an encoding module configured to execute on the processor to create a two-dimensional barcode that includes the billing information received from the service provider;
an output module configured to execute on the processor to output the two-dimensional barcode from the television receiver for display on a display device;
wherein, when the two-dimensional barcode is scanned from the display device into a mobile device, the two-dimensional barcode conveys the billing information to the mobile device such that a user may submit a payment to the service provider through the mobile device.

18. The television receiver of claim 17, wherein:
the billing module is further configured to evaluate the billing information to determine a payment due date; and
the output module is configured to output the two-dimensional code only in response to user input if the payment due date will not occur within a pre-determined period of time.

19. The television receiver of claim 17, wherein:
the billing module is further configured to evaluate the billing information to determine a payment due date; and
the output module is configured to output the two-dimensional code in an icon that overlays other program content also displayed in the display device if payment due date will occur within a pre-determined period of time.

20. The television receiver of claim 17, wherein:
the billing module is further configured to evaluate the billing information to determine a payment due date; and
the output module is configured to suspend normal programming and output the two-dimensional code in a central location of the display device if the payment due date is overdue.
